(19) United States
(12) Patent Application Publication
(10) Pub. No.: US 2024/0418321 A1
(43) Pub. Date: Dec. 19, 2024

(54) STORAGE AND/OR TRANSPORT CONTAINER FOR A CRYOGENIC LIQUEFIED GAS AND METHOD FOR STORING AND/OR FOR TRANSPORTING A CRYOGENIC LIQUEFIED GAS

(71) Applicant: Linde GmbH, Pullach (DE)

(72) Inventor: Herbert AIGNER, Pullach (DE)

(21) Appl. No.: 18/706,882

(22) PCT Filed: Nov. 4, 2022
(86) PCT No.: PCT/EP2022/025496

§ 371 Date: May 2, 2024

(30) Foreign Application Priority Data
Nov. 8, 2021 (EP) 21020553.0

(51) Int. Cl. F17C 3/08

(52) U.S. Cl. CPC F17C 3/08; F17C 2201/0109; F17C 2201/054; F17C 2203/012; F17C 2203/0391; F17C 2203/0629; F17C 2203/0636; F17C 2203/0673; F17C 2221/012; F17C 2221/017; F17C 2223/0161

(57) ABSTRACT

A storage and/or transport container for a cryogenic liquefied gas, the container having a double wall which is formed by an outer container and an inner container, the outer container surrounding the inner container, and the outer container having a cylindrical jacket-like metal wall region which, at mutually opposite ends, i.e., at a first end and a second end, transitions into domed metal wall regions, the wall thickness of the cylindrical jacket-like metal wall region increasing in the direction of the first and second end starting from a central portion which lies centrally between the first and second end. In the central portion, a reinforcement layer is fastened to the cylindrical jacket-like metal wall region and has a fiber-reinforced plastic. The invention also relates to a method for storing and/or for transporting a cryogenic liquefied gas, in which a storage and/or transport container is used.

The invention relates to a storage and/or transport container for a cryogenic liquefied gas and to a method for storing and/or transporting a cryogenic liquefied gas.

### BACKGROUND

Transportable storage containers for cryogenic liquefied gases such as liquid helium and liquid hydrogen (in particular the “Helics” and “Hylics” containers by the applicant), for example in the standard container or UN format (40 feet or 20 feet), are known. Such storage containers can be designed with a vacuum- or nitrogen-insulated double wall and in this case have an inner and an outer container. The outer container is accommodated in a container frame of suitable dimensions, which in particular allows stacking and handling of the storage container, for example by fork-lift trucks or gantry cranes.

The outer containers of such storage containers can be made of stainless steel and have external ribbing which functions as the required stiffening against, for example, the vacuum in the double wall and dynamic loads during transport.

The object of the present invention is to improve the properties of such—in particular, but not necessarily, transportable—storage containers (also referred to here as “storage and/or transport containers”) and the production thereof, as well as corresponding storage and transport methods.

### DISCLOSURE OF THE INVENTION

Against this background, a storage and/or transport container for a cryogenic liquefied gas and a method for storing a cryogenic liquefied gas, having the corresponding features of the independent claims, are proposed. Embodiments of the present invention are respectively the subject matter of the dependent claims and the following description.

According to the invention, a storage and/or transport container for a cryogenic liquefied gas is proposed, said container having a double wall which is formed by an outer container and an inner container, the outer container surrounding the inner container, and the outer container having a cylindrical jacket-like metal wall region which, at mutually opposite ends, i.e., at a first end and a second end of the cylindrical jacket-like metal wall region, transitions into domed metal wall regions.

The domed metal wall regions can be designed, for example, in the form of spherical or ellipsoidal domes, which can also be apically flattened or deformed in another way, for example. The domed metal wall regions can, for example, be formed integrally or monolithically with the cylindrical jacket-like metal wall region or welded thereto or connected in another way. The invention is not limited by the specific design of the domed portions, and corresponding wall regions can be designed and connected as is generally known from the prior art in the field of container technology.

According to the invention, a wall thickness of the cylindrical jacket-like metal wall region increases in the direction of the first and second end (or narrows in the opposite direction) starting from a central portion which lies centrally between the first and second end. The wall thickness of the cylindrical jacket-like wall region is thus lower at least in the central portion than at the ends that transition into the domed metal wall regions. A reinforcement layer, which has a fiber-reinforced plastic, is applied to the cylindrical jacket-like metal wall region at least in the central portion of the cylindrical jacket-like metal wall region.

Storage and/or transport containers for cryogenic liquefied gases, such as liquid helium and liquid hydrogen, must—in particular when they are designed with a vacuum-insulated or nitrogen-insulated double wall and therefore have an inner and an outer container—have stiffening as already mentioned at the outset. The stiffening of the container is necessary due to the vacuum in the insulating space and a typically frameless design between the accommodating frame at the container ends (if a container is designed accordingly). All loads from road, rail and ship transport and from lifting the storage container must be absorbed by the container jacket in such cases.

The stiffening is conventionally formed by external stiffening rings. In these conventional designs, such rings typically result in worse aerodynamics and thus lead to increased fuel consumption during road transport, for example when transported uncovered on appropriate semitrailers. The present invention makes it possible to dispense with such stiffening rings due to the advantageous reinforcement by the fiber-reinforced plastic in the central portion of the cylindrical jacket-like metal wall region, thus enabling the aerodynamics to be improved accordingly at the same time as reducing weight. In this way, embodiments of the present invention allow more cost-effective transport.

Displacing the stiffening rings (for example inwardly), which is possible in principle, would lead to a reduction in size of the inner container and thus reduce the usable volume (payload) of the container, which is already relatively low, particularly in the case of liquid hydrogen containers. Using the fiber-reinforced plastic according to embodiments of the present invention makes it possible to retain the entire volume.

Increasing the wall thickness of the outer container, which is possible in principle, would significantly increase the container weight and the costs on account of the additional metal (typically stainless steel) required for this purpose. However, the present invention makes stiffening by means of cost-effective materials possible. The present invention also makes it possible to flexibly influence the stiffness of the storage container, for example by increasing the thickness or the number of layers of the fiber-reinforced plastic, and to adjust it as desired.

The fiber-reinforced plastic used in embodiments of the present invention has in particular a matrix in the form of a synthetic-resin matrix, thermosetting matrix or thermoplastic matrix. Depending on the field of application and the requirements, different matrices can be used, in particular epoxy resin matrices, as is generally known from the field of composite technology.

In one embodiment of the present invention, embedded in the matrix are reinforcing fibers which are selected from basalt fibers, boron fibers, glass fibers, ceramic fibers, silica fibers, carbon fibers, quartz fibers, metal fibers, aramid fibers, poly(p-phenylene-2,6-benzobisoxazole) fibers, polyester fibers, nylon fibers, polyethylene fibers, polymethyl methacrylate fibers, and any desired combinations of said fibers.

One embodiment of the invention includes the use of carbon-fiber-reinforced plastics (CFRP), i.e., of a composite material in which carbon fibers are embedded in a plastics matrix. As is generally known, the matrix serves to connect the fibers and to fill the gaps. The material epoxy resin can be selected as the matrix. However, other thermosets or thermoplastics can also be used as matrix material. Carbon-fiber-reinforced plastics have the particular advantage of having both low mass and high stiffness.

According to one embodiment of the present invention, a tensile strength of the reinforcement layer and/or of the fiber-reinforced plastic therein is 500 to 1000 newtons per square millimeter and/or a density thereof is 1 to 5 kilograms per cubic decimeter. In this way a correspondingly designed storage and/or transport container with particularly advantageous mechanical properties can be made.

According to one embodiment of the present invention, the reinforcement layer is at least partially laminated onto the cylindrical jacket-like metal wall region. Such lamination can further improve the mechanical properties. The metal cylindrical portion and the reinforcement layer can only be deformed together.

According to one embodiment of the present invention, an extent of the cylindrical jacket-like metal wall region is smaller in the central portion than at the ends of the cylindrical jacket-like metal wall region.

According to one embodiment of the present invention, the cylindrical jacket-like metal wall region is designed to have a thickness of less than 8, 7, 6, 5 or 4 millimeters in at least part of the central portion. As also shown in the table below, the better mechanical properties—in particular of carbon-fiber-reinforced plastics—allow an accordingly thinner container wall to be used. In the table, the respective properties of stainless steel 1.4301, a composite material such as carbon-fiber-reinforced plastic, and a corresponding factor are listed in the table columns. The tensile strength is indicated in the form of the plastic 0.2% yield strength.

TABLE 1

| | Stainless steel | | Composite | | Factor |
|---|---|---|---|---|---|
| Density | 7.8 | kg/dm³ | 1.5 | kg/dm³ | 0.19 |
| Tensile strength | 210 | N/mm² | 800 | N/mm² | 3.80 |
| Min. wall | 10 | mm | 2.7 | mm | −73% |
| thickness | | | (calculated) | | |
| Material usage | 11,000 | kg | 550 | kg | −95% |

According to one embodiment of the present invention, the domed metal wall regions are each connected to container frames, but in particular the container frames are not connected to one another via any other connecting structures apart from the container itself. In a corresponding embodiment of the invention, the storage and/or transport container can thus be integrated into the existing container infrastructure. The advantages of the present invention arise in particular in the case of road transport. According to one embodiment of the present invention, the storage and/or transport container is designed in a standard container format having a length of 40 feet, but optionally also 20 feet.

As already mentioned, the domed metal wall regions are provided in particular in the form of unmodified or modified spherical or ellipsoidal domes. The domed metal wall regions can in particular be integrally formed with the cylindrical jacket-like metal wall region or be integrally joined thereto, as likewise already mentioned. The double wall can in particular be designed to be evacuated or filled with an insulating or cooling fluid or be filled with an insulating material. In particular in the case of vacuum insulation, there is a need for reinforcement which the present invention can advantageously meet.

In one embodiment of the present invention, the storage and/or transport container is designed for storing and/or transporting liquid hydrogen or liquid helium as the cryogenic liquefied gas. The storage and/or transport container can in this case be designed for storing and/or transporting 20 to 41 cubic meters of the cryogenic liquefied gas. It is thus a large container, such as the one mentioned above, and can be accommodated in a container frame and transported, for example, on a semitrailer. In particular in the case of large containers of this kind, the advantages that can be achieved in embodiments of the invention, such as better wind resistance values and lower weight, are of particular relevance for reducing the transport costs.

The present invention also relates to a method for storing and/or for transporting a cryogenic liquefied gas, in which a storage and/or transport container as described above in advantageous embodiments of the invention is used. This method benefits from the advantages described above with respect to the storage and/or transport container according to the invention and its embodiments, to which reference can therefore be expressly made at this point.

The present invention is explained in more detail hereafter with reference to the accompanying drawing, which illustrates an embodiment of the present invention.

It is to be understood that the features mentioned above and explained below can be used not only in the combination specified in each case, but also in other combinations or by themselves, without departing from the scope of the present invention.

### BRIEF DESCRIPTION OF THE DRAWINGS

FIG. 1 illustrates a storage and/or transport container according to an embodiment of the invention.

### DETAILED DESCRIPTION OF THE DRAWINGS

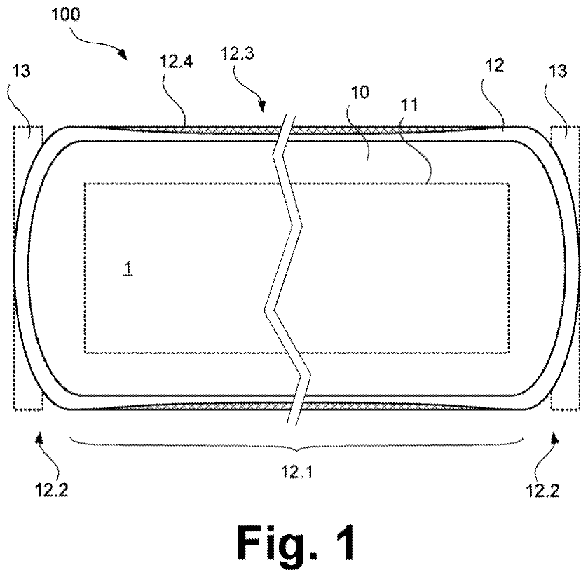

FIG. 1 illustrates a storage and/or transport container according to an embodiment of the present invention and is designated as a whole by 100.

The storage and/or transport container 100 is shown here in a highly simplified and schematic manner, in which, in particular, a wall thickness is shown in a highly exaggerated manner in order to illustrate embodiments of the invention.

The storage and/or transport container 100 is provided for storing and/or transporting a cryogenic liquefied gas, which is indicated here by 1. The storage and/or transport container 100 has a double wall 10 which can be vacuum-insulated, for example. The double wall 10 is formed by an outer container 12 and an inner container 11, with the inner container again being illustrated in a highly simplified manner.

The outer container 12 surrounds the inner container 11 and the outer container 12 has a cylindrical jacket-like metal wall region, which is indicated here by 12.1 and, at mutually opposite ends, i.e., at a first end and a second end, transitions into domed metal wall regions 12.2.

A wall thickness of the cylindrical jacket-like metal wall region 12.1 increases in the direction of the first and second end starting from a central portion 12.3 which lies centrally between the first and second end; the example illustrated here shows a gradual increase, but the increase in wall thickness can also be incremental (in one or more increments). This does not limit the invention.

In the central portion 12.3, a reinforcement layer 12.4 is fastened to the cylindrical jacket-like metal wall region 12.1 and has a fiber-reinforced plastic. As illustrated, a change in thickness of the reinforcement layer corresponding to the change in wall thickness is possible here, but other embodiments can also be provided within the scope of the present invention.

The reinforcement layer 12.4 can in particular be at least partially laminated onto the cylindrical jacket-like metal wall region 12.1, as already mentioned. Furthermore, although not explicitly illustrated here, an extent of the cylindrical jacket-like metal wall region 12.1 can be smaller in the central portion 12.3 than at the ends of the cylindrical jacket-like metal wall region 12.1. In the example illustrated here, the domed metal wall regions 12.2 are each connected to container frames 13 so that a corresponding storage and/or transport container 100, which can in particular be designed in this way in a standard container format with a length of 20 or 40 feet, can be transported accordingly.

1. A storage and/or transport container for a cryogenic liquefied gas, said container having a double wall which is formed by an outer container and an inner container,
wherein the outer container surrounds the inner container, wherein the outer container has a cylindrical jacket-like wall region which, at mutually opposite ends, transitions into domed metal wall regions,
wherein a wall thickness of the cylindrical jacket-like metal wall region increases in the direction of the first and second end starting from a central portion which lies centrally between the first and second end, and
wherein, in the central portion, a reinforcement layer is fastened to the cylindrical jacket-like metal wall region and has a fiber-reinforced plastic.

2. The storage and/or transport container according to claim 1, wherein the fiber-reinforced plastic has a matrix in the form of a synthetic-resin matrix, thermosetting matrix or thermoplastic matrix.

3. The storage and/or transport container according to claim 2, wherein embedded in the matrix are reinforcing fibers which are selected from basalt fibers, boron fibers, glass fibers, ceramic fibers, silica fibers, carbon fibers, quartz fibers, metal fibers, aramid fibers, poly(p-phenylene-2,6-benzobisoxazole) fibers, polyester fibers, nylon fibers, polyethylene fibers, polymethyl methacrylate fibers, and any combinations of said fibers.

4. The storage and/or transport container according to claim 2, wherein a tensile strength of the reinforcement layer and/or of the fiber-reinforced plastic is 500 to 1000 newtons per square millimeter and/or a density is 1 to 5 kilograms per cubic decimeter.

5. The storage and/or transport container according to claim 1, wherein the reinforcement layer is at least partially laminated onto the cylindrical jacket-like metal wall region.

6. The storage and/or transport container according to claim 1, wherein an extent of the cylindrical jacket-like metal wall region is smaller in the central portion than at the ends of the cylindrical jacket-like metal wall region.

7. The storage and/or transport container according to claim 1, wherein the cylindrical jacket-like metal wall region is designed to have a thickness of less than 8, 7, 6, 5 or 4 millimeters in at least part of the central portion.

8. The storage and/or transport container according to claim 1, wherein the domed metal wall regions are each connected to container frames.

9. The storage and/or transport container according to claim 8, which is designed in a standard container format having a length of 20 or 40 feet.

10. The storage and/or transport container according to claim 1, wherein the domed metal wall regions are provided in the form of unmodified or modified spherical or ellipsoidal domes.

11. The storage and/or transport container according to claim 1, wherein the domed metal wall regions are integrally formed with the cylindrical jacket-like metal wall region or are integrally joined thereto.

12. The storage and/or transport container according to claim 1, wherein the double wall is designed to be evacuated or filled with an insulating or cooling fluid or is filled with an insulating material.

13. The storage and/or transport container according to claim 1, which is designed for storing and/or transporting liquid hydrogen or liquid helium as the cryogenic liquefied gas.

14. The storage and/or transport container according to claim 1, which is designed for storing and/or transporting 20 to 41 cubic meters of the cryogenic liquefied gas.

15. A method for storing and/or transporting a cryogenic liquefied gas, wherein a storage and/or transport container according to claim 1 is used.
